(19) United States
(12) Patent Application Publication
(10) Pub. No.: US 2025/0020529 A1
(43) Pub. Date: Jan. 16, 2025

(54) PRESSURE SENSOR APPARATUS

(71) Applicant: FUJI ELECTRIC CO., LTD., Kawasaki-shi (JP)

(72) Inventor: Kimihiro ASHINO, Matsumoto-city (JP)

(73) Assignee: FUJI ELECTRIC CO., LTD., Kawasaki-shi (JP)

(21) Appl. No.: 18/676,266

(22) Filed: May 28, 2024

(30) Foreign Application Priority Data
Jul. 11, 2023 (JP) 2023-114024

(51) Int. Cl. G01L 19/00; G01L 19/06; G01L 19/14

(52) U.S. Cl. CPC G01L 19/0038; G01L 19/06; G01L 19/141

(57) ABSTRACT

A pressure sensor apparatus, including: a substrate; a sensor provided on the substrate and configured to measure absolute pressure; a cover attached to the substrate to form a housing space, in which the sensor is housed, with the substrate; and a shield member. The cover is attached to the substrate with the shield member disposed therebetween and fully blocking passage of air therebetween. The cover has a hole through which the housing space communicates with an outside of the housing space.

### CROSS-REFERENCE TO RELATED APPLICATION

The present application claims priority pursuant to 35 U.S.C. § 119 from Japanese patent application number 2023-114024 filed on Jul. 11, 2023, the entire disclosure of which is hereby incorporated by reference herein.

### BACKGROUND

### Technical Field

The present disclosure relates to a pressure sensor apparatus.

A typical pressure sensor apparatus includes a pressure sensor having a diaphragm provided on a semiconductor substrate, and a package in which the pressure sensor is housed (refer to Japanese Patent Laid-open No. 2015-222175, for example).

In some pressure sensor apparatuses, a tube is directly attached to a cap that covers the package. In such a pressure sensor apparatus, when the tube is attached to the cap, force is sometimes applied to the semiconductor substrate and a terminal (so-called a lead frame) extending from the package, which potentially degrades measurement accuracy of the pressure sensor apparatus.

### SUMMARY

A first aspect of an embodiment of the present disclosure to solve the above-mentioned problem is a pressure sensor apparatus that includes a substrate; a sensor provided on the substrate and configured to measure absolute pressure; a cover attached to the substrate to form a housing space, in which the sensor is housed, with the substrate; and a shield member, wherein the cover is attached to the substrate with the shield member disposed therebetween and fully blocking passage of air therebetween, and the cover has a hole through which the housing space communicates with an outside of the housing space.

A second aspect of an embodiment of the present disclosure to solve the above-mentioned problem is a pressure sensor apparatus that includes a substrate; a first sensor provided on the substrate and configured to measure absolute pressure; a second sensor provided on the substrate and configured to measure the absolute pressure; a cover attached to the substrate to form a first housing space, in which the first sensor is housed, and a second housing space, in which the second sensor is housed, with the substrate; and a shield member, wherein the cover has a first hole through which the first housing space communicates with an outside of the first housing space, and a second hole through which the second housing space communicates with an outside of the second housing space, the shield member is positioned between the cover and the substrate, and is configured to fully block passage of air therebetween, and the shield member includes a first part and a second part that enclose the first housing space and the second housing space respectively in a plan view of the pressure sensor apparatus, and the first part and the second part share a common part.

### BRIEF DESCRIPTION OF THE DRAWINGS

FIG. 1A is a perspective view of a typical pressure sensor apparatus 10;

FIG. 1B is a partial cross-sectional view along line A-A in FIG. 1A;

FIG. 2 is a cross-sectional view of a sensor 21;

FIG. 3A is a perspective view illustrating a pressure sensor apparatus 15 or 16;

FIG. 3B is a partial cross-sectional view of the pressure sensor apparatus 15 along line B-B in FIG. 3A;

FIG. 3C is a partial cross-sectional view of the pressure sensor apparatus 16 along line B-B in FIG. 3A;

FIG. 4A is a perspective view illustrating a pressure sensor apparatus 17;

FIG. 4B is a plan view of the pressure sensor apparatus 17;

FIG. 4C is a partial cross-sectional view along line C-C in FIG. 4B;

FIG. 5A is an exploded perspective view of a pressure sensor apparatus 18;

FIG. 5B is a diagram for description of a cover 320 and a shield member 350;

FIG. 5C is a plan view of the pressure sensor apparatus 18;

FIG. 5D is a partial cross-sectional view along line E-E in FIG. 5C;

FIG. 5E is a partial cross-sectional view along line F-F in FIG. 5C;

FIG. 6 is a cross-sectional view of a sensor 310a along line D-D in FIG. 5A;

FIG. 7A is an exploded perspective view of a pressure sensor apparatus 19;

FIG. 7B is a diagram for description of a second member 402;

FIG. 7C is a plan view of the pressure sensor apparatus 19;

FIG. 7D is a partial cross-sectional view along line G-G in FIG. 7C;

FIG. 7E is a partial cross-sectional view along line H-H in FIG. 7C;

FIG. 8 is a diagram illustrating an example of a sensor 22; and

FIG. 9 is a diagram illustrating an example of the pressure sensor apparatus 15 including the sensor 22.

### DETAILED DESCRIPTION

At least following matters will become apparent from the present description and the accompanying drawings. The same or equivalent components, members, and the like illustrated in the drawings are given by the same reference numerals, and a description thereof is omitted as appropriate.

### Typical Pressure Sensor Apparatus

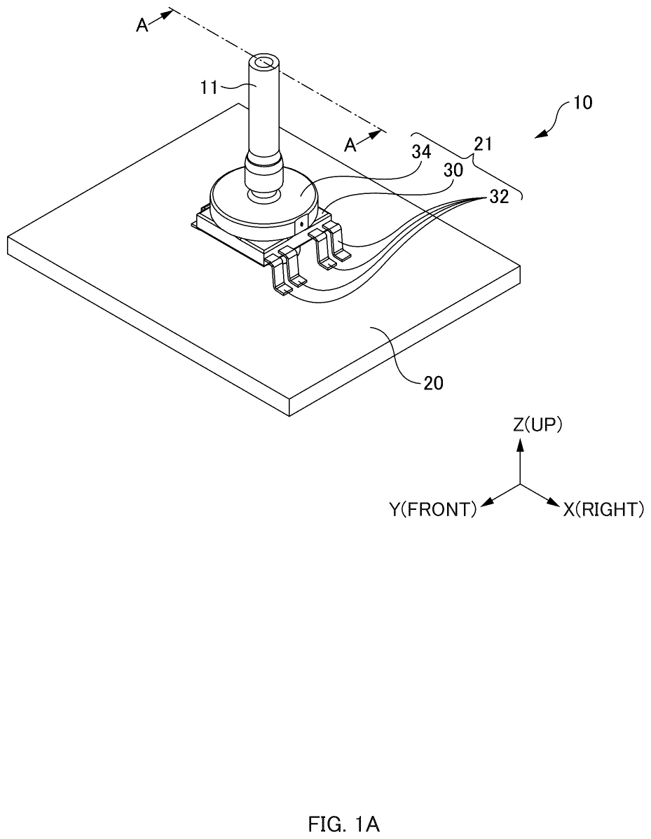

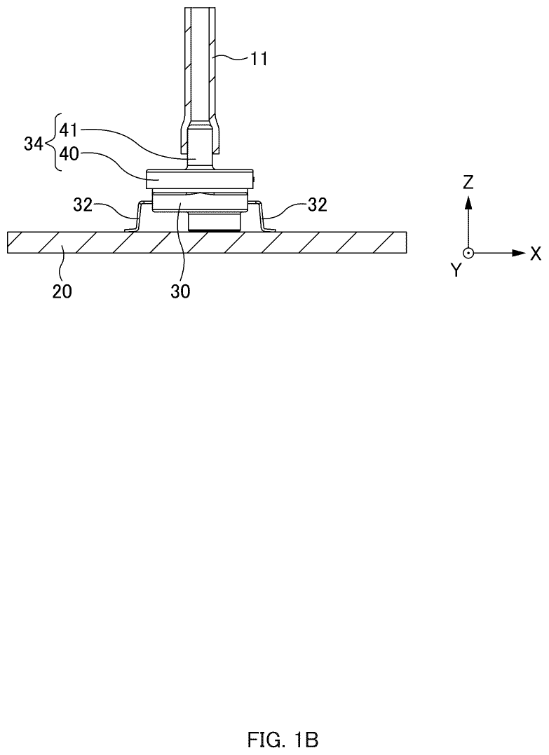

FIG. 1A is a perspective view of a typical pressure sensor apparatus 10, and FIG. 1B is a partial cross-sectional view along line A-A in FIG. 1A.

### <<Definitions of Directions and the Like>>

First, directions and the like of the pressure sensor apparatus 10 are defined with reference to FIG. 1A. A direction from left to right on the sheet in a longitudinal direction of a substrate 20 on a plane is defined as a “+X direction”, and its opposite direction (in other words, a direction from right to left on the sheet in the longitudinal direction of the substrate 20) is defined as a “−X direction”.

A direction from back to front on the sheet in a width direction of the substrate 20 is defined as a “+Y direction”, and its opposite direction (in other words, a direction from front to back on the sheet in the width direction of the substrate 20) is defined as a “−Y direction”. In addition, a direction orthogonal to the substrate 20 and pointing upward on the sheet is defined as a “+Z direction”, and its opposite direction (in other words, a direction orthogonal to the substrate 20 and pointing downward) is defined as a “−Z direction”.

Both the +X direction and the −X direction are also simply referred to as an “X direction”. Similarly, both the +Y direction and the −Y direction are also simply referred to as a “Y direction”. In addition, both the +Z direction and the −Z direction are also simply referred to as a “Z direction”.

In FIG. 1A, the +X direction, the +Y direction, and the +Z direction are illustrated as line segments with arrows to facilitate understanding of the directions and the like of the pressure sensor apparatus 10. In the following description, the +X direction is referred to as a “right direction”, the −X direction is referred to as a “left direction”, and the X direction is referred to as a “right-left direction” in some cases. The +Y direction is referred to as a “front direction (or a front side)”, the −Y direction is referred to as a “back direction (or a back side)”, and the Y direction is referred to as a “front-rear direction” in some cases. The +Z direction is referred to as an “upward direction (or an upside direction)”, the −Z direction is referred to as a “downward direction (or a downside direction)”, and the Z direction is referred to as an “up-down direction” or a “height direction” in some cases.

The above-described definitions of directions and the like apply throughout the present specification unless otherwise stated.

### <<Configuration of Pressure Sensor Apparatus 10>>

The pressure sensor apparatus 10 is an apparatus to measure the pressure of gas that flows in and out through a tube 11, and the pressure sensor apparatus 10 is configured to include the substrate 20 and a sensor 21. The substrate 20 is a member having an upper surface (hereinafter, also referred to as an “upside surface” as appropriate) to which the sensor 21 is attached. For example, pattern wiring for applying power supply voltage to the sensor 21, pattern wiring for transmitting signals from the sensor 21, and a ground pattern (not illustrated) are formed on the substrate 20.

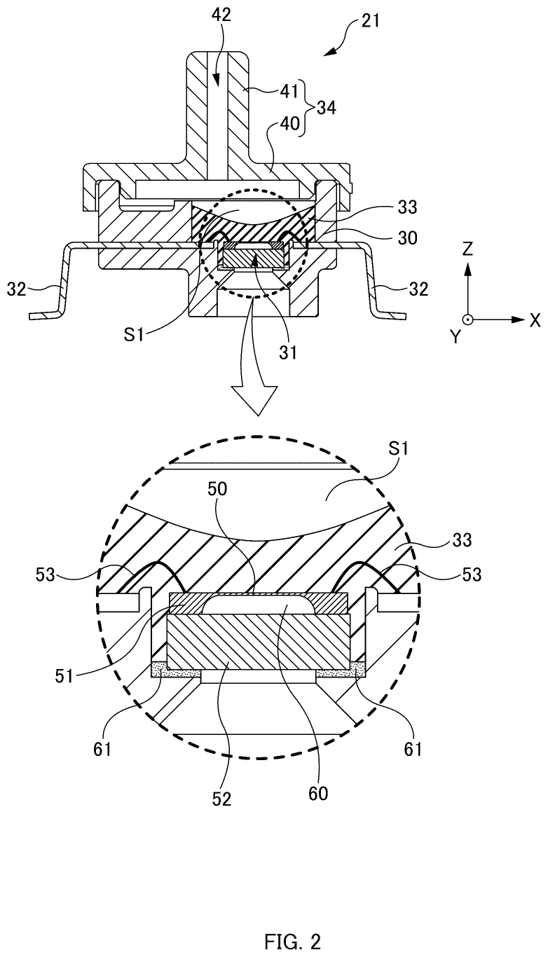

The sensor 21 is a device to measure the pressure of gas flowing in or out through the tube 11 and the sensor 21 is configured to include, for example, a package 30, a measurement unit 31, terminals 32, a protection member 33, and a cap 34 as illustrated in FIG. 2.

The package 30 is a member made of, for example, resin and formed with a recessed part in which the measurement unit 31 (described later) is housed. Each terminal 32 is a metal member corresponding to so-called a lead frame and electrically couples a semiconductor chip 51 (described later) included in the measurement unit 31 to the substrate 20 through a wire 53 (described later). The package 30 corresponds to a “housing part” in which the semiconductor chip 51 (that is, a semiconductor substrate) is housed.

The protection member 33 is a protection gel protecting the semiconductor chip 51 and the wires 53, of the measurement unit 31. The protection member 33 is, for example, a silicone gel but may be a fluorine gel or the like. The cap 34 is a member that covers the package 30 and to which the tube 11 is attached, and is made of, for example, resin. The cap 34 includes a lid part 40 having a circular shape in a plan view seen from the upward direction (+Z direction), and an introduction pipe 41 into which the tube 11 is inserted.

The introduction pipe 41 is a cylindrical part extending in the upward direction at a substantially central part of the lid part 40 in a circular shape. A hole 42 is formed inside the introduction pipe 41, and accordingly, gas can flow into or out of the inside of the cap 34 through the hole 42.

The cap 34 is attached to the package 30 by a bonding agent (not illustrated) or the like such that a space (hereinafter, a space S1) formed inside the sensor 21 by the package 30 and the cap 34 is sealed when the hole 42 is blocked.

### <<Details of Measurement Unit 31>>

The measurement unit 31 is housed in the recessed part formed in the package 30 and measures the absolute pressure in the sensor 21, and the measurement unit 31 is configured to include the semiconductor chip 51 in which a diaphragm 50 is formed, a base 52, and the wires 53. The “absolute pressure” is pressure with respect to pressure in vacuum. The measurement unit 31 is housed in the recessed part of the package 30 and then fixed by a bonding agent 61.

The semiconductor chip 51 is a silicon chip in which the diaphragm 50 and a bridge circuit (not illustrated) including a plurality of piezo resistors on the diaphragm 50 are formed. The base 52 is a member (for example, a glass member) supporting the semiconductor chip 51 and is anodically joined to the semiconductor chip 51. A vacuum space between the semiconductor chip 51 and the base 52 is a vacuum reference chamber 60. The semiconductor chip 51 corresponds to a “semiconductor substrate”.

Each wire 53 is a metal member (so-called a bonding wire) coupling a pad (not illustrated) on the upside surface of the semiconductor chip 51 to a terminal 32.

In such a pressure sensor apparatus 10, force in the downward direction (−Z direction) is applied to the cap 34 including the introduction pipe 41 when the tube 11 is attached to the introduction pipe 41. As a result, force is also applied to the terminals 32 and the measurement unit 31 in some cases, which potentially degrades measurement accuracy of the pressure sensor apparatus 10. The following describes pressure sensor apparatuses of the present embodiment, which are capable of preventing degradation of the measurement accuracy.

### Present Embodiment

### <<Pressure Sensor Apparatus 15>>

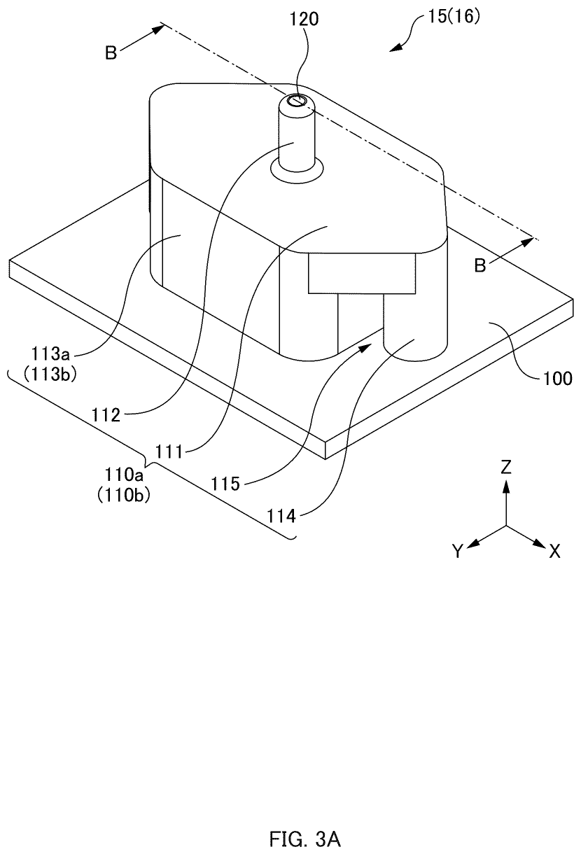

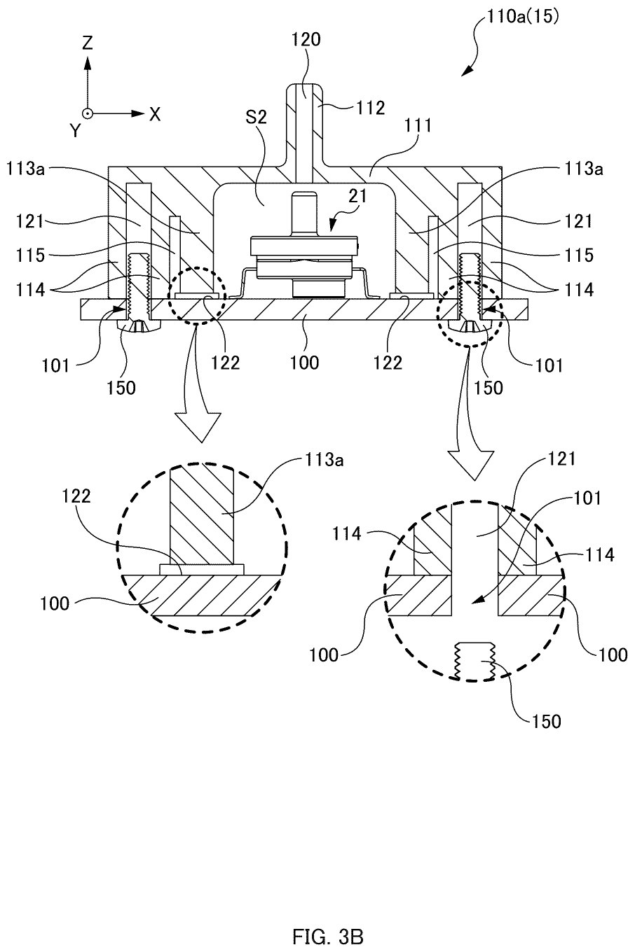

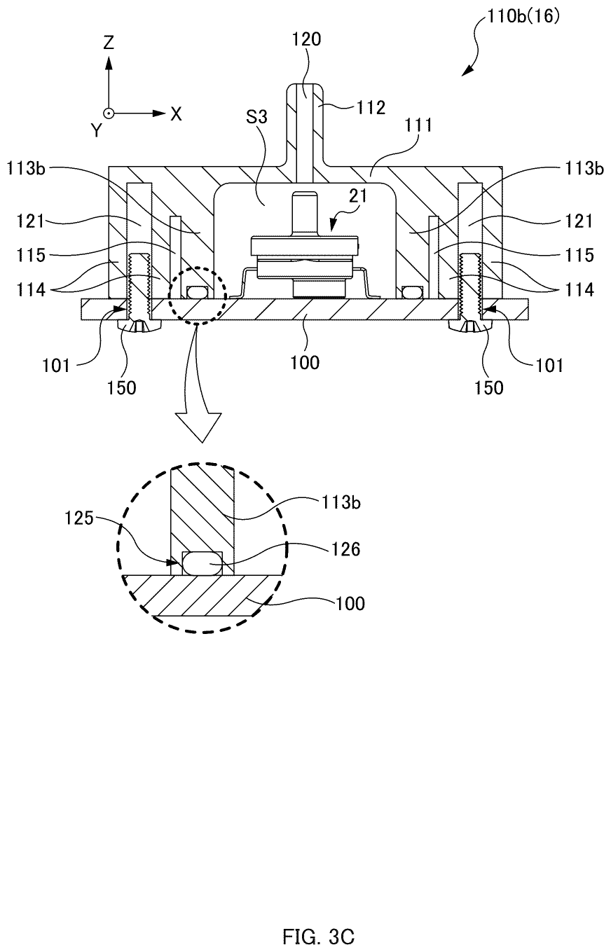

FIG. 3A is a perspective view of a pressure sensor apparatus 15, and FIG. 3B is a partial cross-sectional view along line B-B in FIG. 3A. The pressure sensor apparatus 15 is configured to include a substrate 100, the sensor 21, a cover 110a, and screws 150. The sensor 21 of the pressure sensor apparatus 15 is described above and thus detailed description thereof is omitted.

The substrate 100 is a similar member to or the same member as the substrate 20, and has an upside surface on which the sensor 21 is attached and a plurality of wiring patterns are formed. As illustrated in the lower-right enlarged view in FIG. 3B, the substrate 100 is formed with openings 101 corresponding to the screws 150 (described later).

The cover 110a is attached to the upside surface of the substrate 100 from above to form a housing space S2 (described later in detail) in which the sensor 21 is housed. The cover 110a includes a ceiling part 111, an introduction pipe 112, a wall part 113a, attachment parts 114, and slits 115.

The ceiling part 111 is a plate part corresponding to a ceiling part of the cover 110a. The cylindrical introduction pipe 112 extending upward is formed at a substantially central part of the ceiling part 111 in a plan view seen from the upward direction. A hole 120 is formed inside the introduction pipe 112 so that gas is flowed in and out between the housing space S2 and an external space, through the hole 120.

The wall part 113a extending in the downward direction is formed from the back surface of the ceiling part 111. Specifically, the tubular wall part 113a is formed on the back surface of the ceiling part 111 to surround the sensor 21.

The attachment parts 114 for attaching the cover 110a to the substrate 100 extend in the downward direction from the back surface of the ceiling part 111 at respective end parts of the back surface of the ceiling part 111 in the right-left direction. As illustrated in the lower-right enlarged view in FIG. 3B, each attachment part 114 is formed with a screw hole 121 corresponding to a screw 150 (described later). Each slit 115 is formed from the lower side of the cover 110a to the upper side, between the wall part 113a and the corresponding attachment part 114.

In the pressure sensor apparatus 15, for example, a bonding agent 122 as so-called a “seal” is applied at a lower end part of the wall part 113a before the cover 110a is attached to the substrate 100. In the present embodiment, the cover 110a is disposed such that the sensor 21 of the substrate 100 is positioned inside the tubular wall part 113a and the center of each opening 101 matches the center of the opening of the corresponding screw hole 121.

Then, the screws 150 are inserted into the screw holes 121 through the openings 101 from the back surface side of the substrate 100, and accordingly, the cover: and the substrate 100 are fixed to each other by the screws 150. As a result, the cover 110a is attached to the substrate 100. The bonding agent 122 eliminates the gap between the wall part 113a and the substrate 100 when the cover 110a is attached to the substrate 100 (fixed by the screws 150).

Accordingly, in the present embodiment, the bonding agent 122 shields the inside of the housing space S2 from the outside so that the housing space S2 is sealed when the hole 120 is blocked. The “housing space S2” is a space surrounded by the ceiling part 111, the wall part 113a, the bonding agent 122, and the substrate 100.

As in FIG. 1A, a tube (not illustrated) is attached to the introduction pipe 112 of the cover 110a of the pressure sensor apparatus 15. In the present embodiment, the cover 110a directly contacts the substrate 100 but does not directly contact the sensor 21. Thus, force is not directly applied to the sensor 21 through the cover 110a, and accordingly, the pressure sensor apparatus 15 of the present embodiment can accurately measure absolute pressure in the housing space S2.

Moreover, in the present embodiment, since the slits 115 are each provided between the wall part 113a and the corresponding attachment part 114, it is possible to reduce force conveyed from the attachment parts 114 to the wall part 113a when the screws 150 are inserted into the screw holes 121 of the attachment parts 114. Thus, it is possible to reduce influence on the sensor 21 when the cover 101a is fixed to the substrate 100.

The bonding agent 122 corresponds to a “shield member” for sealing the housing space S2 in a state in which the hole 120 is blocked.

### <<Pressure Sensor Apparatus 16>>

A pressure sensor apparatus 16 is an apparatus including an O ring 126 as a “seal” in place of the bonding agent 122 of the pressure sensor apparatus 15 and the pressure sensor apparatus 16 is configured to include the substrate 100, the sensor 21, a cover 110b, and the screws 150 as illustrated in FIGS. 3A and 3C. The pressure sensor apparatus 16 is the same as the pressure sensor apparatus 15 except for the cover 110b and the O ring 126, and thus the following description will be made on the cover 110b and the O ring 126.

The cover 110b is a similar member to or the same member as the cover 110a, and attached to the upside surface of the substrate 100 from above to form a housing space S3 in which the sensor 21 is housed. The cover 110b includes the ceiling part 111, the introduction pipe 112, a wall part 113b, the attachment parts 114, and the slits 115. The cover 110b is the same as the cover 110a except for the wall part 113b, and thus the following description will be made on the wall part 113b.

The wall part 113b is a member extending in the downward direction from the back surface of the ceiling part 111. In the present embodiment, the tubular wall part 113b is formed on the back surface of the ceiling part 111 to surround the sensor 21. A groove 125 is formed at a lower end part of the wall part 113b. The O ring 126 made of resin is fitted to the groove 125.

The O ring 126 eliminates the gap between the wall part 113b and the substrate 100 when the cover 110b is attached to the substrate 100 (fixed by the screws 150). Accordingly, in the present embodiment, the O ring 126 shields the inside of the housing space S3 from the outside so that the housing space S3 is sealed when the hole 120 is blocked. The “housing space S3” is a space surrounded by the ceiling part 111, the wall part 113b, the O ring 126, and the substrate 100.

As in FIG. 1A, a tube (not illustrated) is attached the introduction pipe 112 of the cover 110b of the pressure sensor apparatus 16. In the present embodiment, the cover 110b directly contacts the substrate 100 but does not directly contact the sensor 21. Thus, force is not directly applied to the sensor 21 through the cover 110b, and accordingly, the pressure sensor apparatus 16 of the present embodiment can accurately measure absolute pressure in the housing space S3.

In the present embodiment, since the slits 115 are each provided between the wall part 113b and the corresponding attachment part 114, it is possible to reduce force conveyed from the attachment parts 114 to the wall part 113b when the 150 are inserted into the screw holes 121 of the screws attachment parts 114. Thus, it is possible to reduce influence on the sensor 21 when the cover 110b is fixed to the substrate 100.

The O ring 126 corresponds to a “shield member” for sealing the housing space S3 in a state in which the hole 120 is blocked.

### <<Pressure Sensor Apparatus 17>>

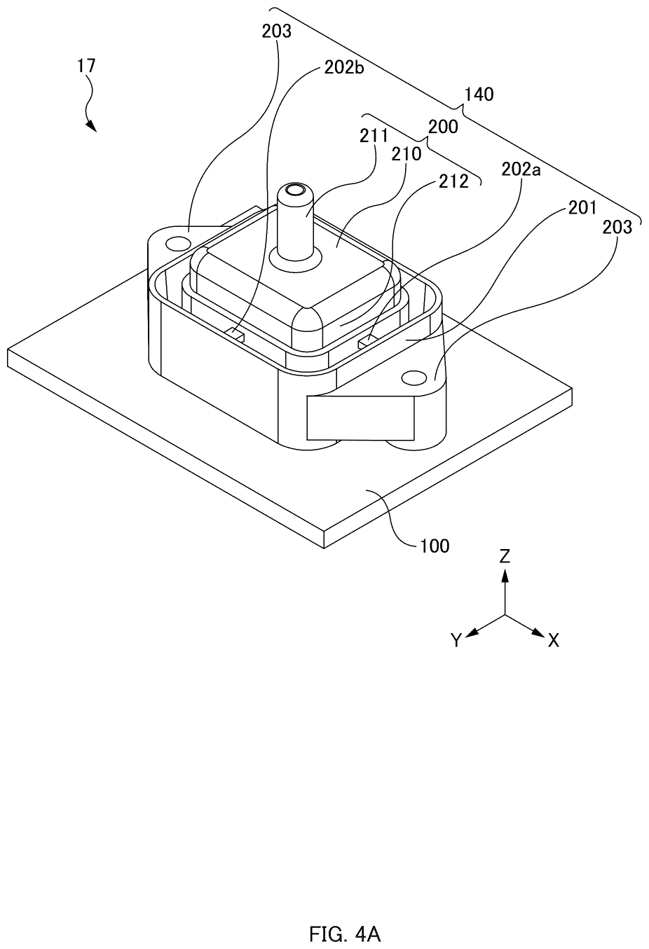

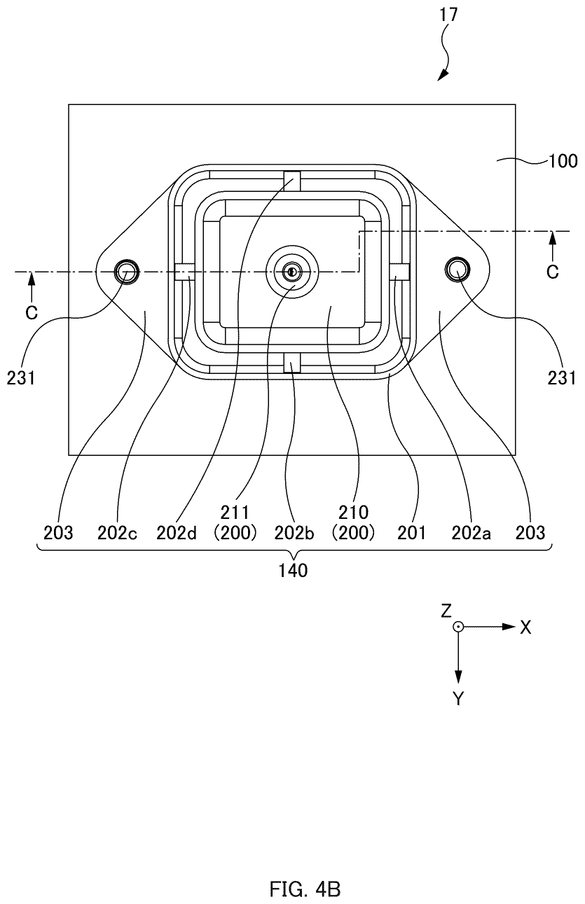

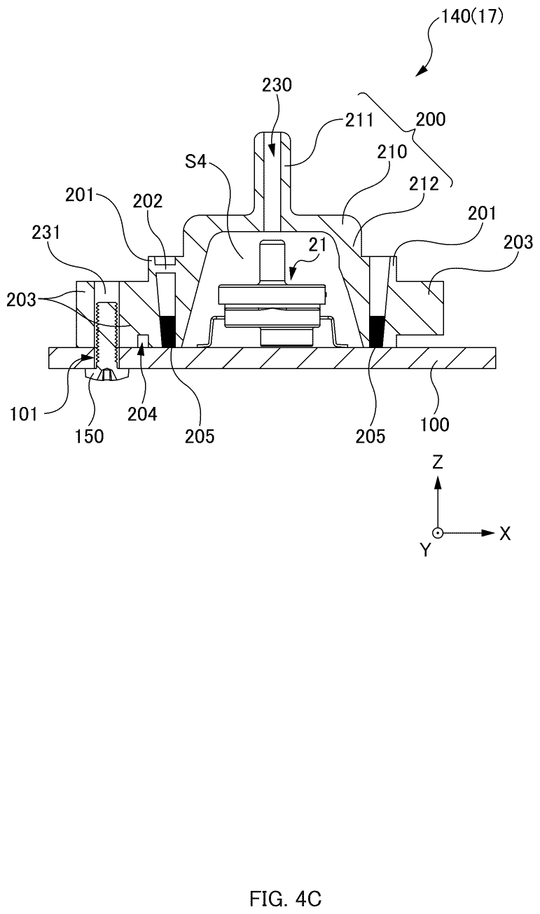

FIG. 4A is a perspective view of a pressure sensor apparatus 17, FIG. 4B is a plan view of the pressure sensor apparatus 17, and FIG. 4C is a partial cross-sectional view along line C-C in FIG. 4B. The pressure sensor apparatus 17 is configured to include the substrate 100, the sensor 21, a cover 140, and the screws 150. The pressure sensor apparatus 17 is the same as the pressure sensor apparatus 15 in FIG. 3A except for the cover 140, and thus the following description will be mainly made on the cover 140. In FIG. 4B, illustration of a bonding agent 205 is omitted for convenience.

The cover 140 is attached to the upside surface of the substrate 100 from above to form a housing space S4 (described later in detail) in which the sensor 21 is housed. The cover 140 includes a first member 200, a second member 201, and coupling parts 202a to 202d, attachment parts 203, and slits 204.

The first member 200 is a member covering the sensor 21 from above and forming the housing space S4 in which the sensor 21 is housed, and the first member 200 is configured to include a ceiling part 210, an introduction pipe 211, and a wall part 212. The ceiling part 210 is a plate part corresponding to a ceiling part of the first member 200. The cylindrical introduction pipe 211 extending upward is formed at a substantially central part of the ceiling part 210 in a plan view seen from the upward direction.

A hole 230 is formed inside the introduction pipe 211 so that gas is flowed in and out between the housing space S4 and an external space, through the hole 230.

The wall part 212 extending in the downward direction in a cylindrical shape is formed from the back surface of the ceiling part 210. Specifically, the wall part 212 is formed on the back surface of the ceiling part 210 to surround the sensor 21.

The second member 201 is a tubular member surrounding the first member 200. Accordingly, a gap is formed between the first member 200 and the second member 201. The height of the second member 201 from the upside surface of the substrate 100 is lower than the height of the first member 200 from the upside surface of the substrate 100.

The coupling part 202a is a member coupling the first member 200 and the second member 201 at the right surface of the first member 200 as illustrated in FIG. 4A. The coupling part 202b couples the first member 200 and the second member 201 at the front surface of the first member 200, and the coupling part 202c couples the first member 200 and the second member 201 at the left surface of the first member 200. The coupling part 202d couples the first member 200 and the second member 201 at the back surface of the first member 200.

The attachment parts 203 are parts for attaching the cover 140 to the substrate 100 and formed at respective end parts of the second member 201 in the right-left direction. Screw holes 231 corresponding to the screws 150 (described later) are formed at the attachment parts 203. In the present embodiment, each slit 204 is formed from the lower side of the cover 140 to the upper side between the second member 201 and the corresponding attachment part 203.

In the present embodiment, the cover 140 is disposed such that the sensor 21 of the substrate 100 is positioned inside the tubular wall part 212 and the center of the opening 101 matches the center of the opening of the corresponding screw hole 231.

The screws 150 are inserted into the screw holes 231 through the openings 101 from the back surface side of the substrate 100, and accordingly, the cover 140 and the substrate 100 are fixed to each other by the screws 150. As a result, the cover 140 is attached to the substrate 100.

As described above, a gap is formed between the first member 200 and the second member 201. In the present embodiment, when the bonding agent 205 is filled between the first member 200 and the second member 201, they can eliminate the gap between the first member 200 and the second member 201. The bonding agent 205 of the present embodiment is, for example, a potting material of silicon resin, but is not limited thereto and may be a potting material of urethane resin or epoxy resin.

The coupling parts 202a to 202d is provided at a position separated from the substrate 100 when the cover 140 is attached to the substrate 100. Accordingly, the bonding agent 205 can reliably eliminate the gap between the first member 200 and the second member 201.

The bonding agent 205 of the present embodiment shields the inside of the housing space S4 from the outside so that the housing space S4 is sealed when the hole 230 is blocked. The “housing space S4” is a space surrounded by the inside of the first member 200, the bonding agent 205, and the substrate 100.

As in FIG. 1A, a tube (not illustrated) is attached to the introduction pipe 211 of the cover 140 of the pressure sensor apparatus 17. In the present embodiment, the cover 140 directly contacts the substrate 100 but does not directly contact the sensor 21. Thus, force is not directly applied to the sensor 21 through the cover 140, and accordingly, the pressure sensor apparatus 17 of the present embodiment can accurately measure absolute pressure in the housing space S4.

In the present embodiment, since the slits 204 are each provided between the second member 201 and the corresponding attachment part 203, it is possible to reduce force conveyed from the attachment parts 203 to the first member 200 when the screws 150 are inserted into the screw holes 231 2 of the attachment parts 203. Thus, it is possible to reduce influence on the sensor 21 when the cover 140 is fixed to the substrate 100.

The bonding agent 205 corresponds to a “shield member” for sealing the housing space S4 in a state in which the hole 230 is blocked.

### <<Pressure Sensor Apparatus 18>>

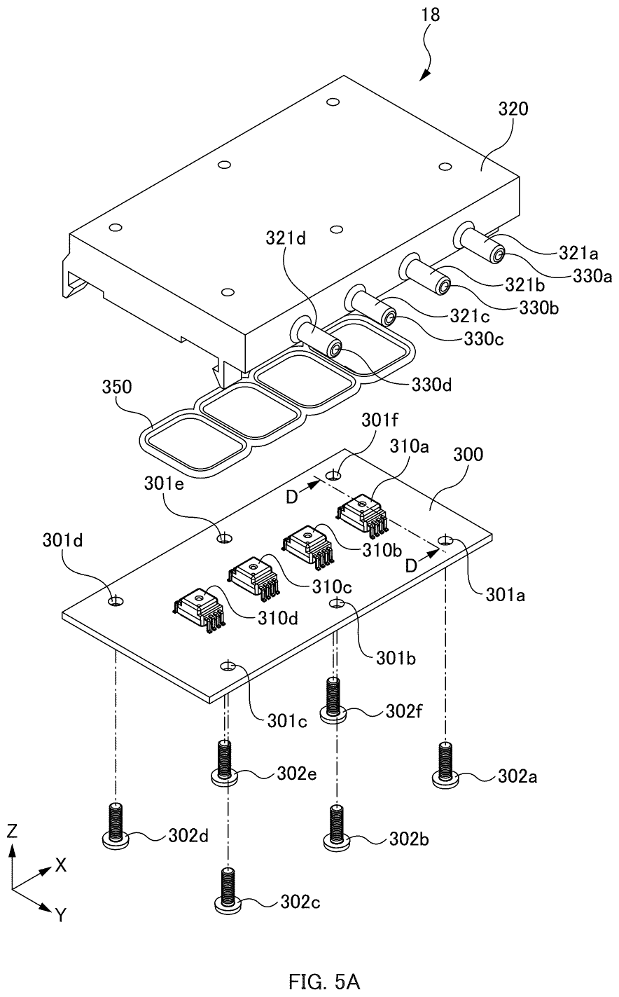

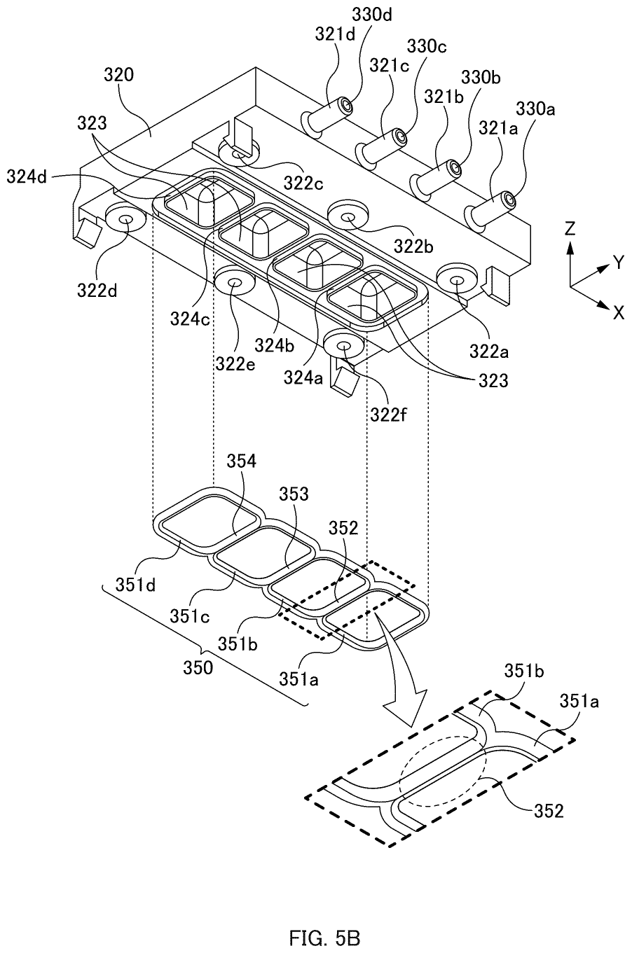

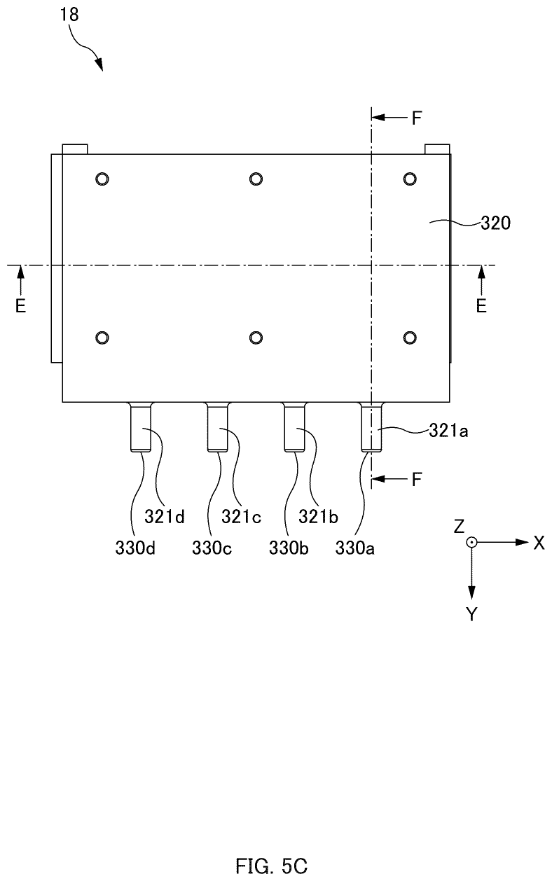

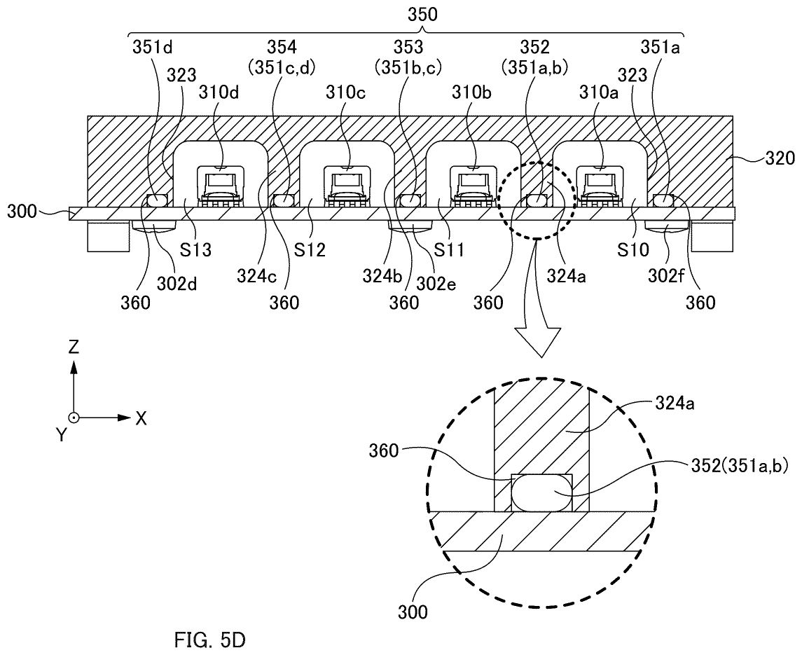

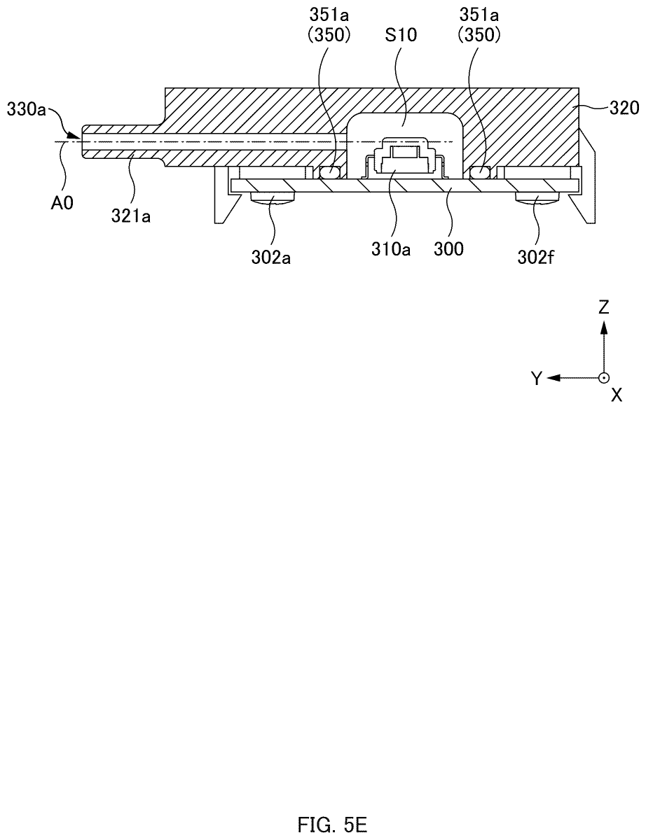

FIG. 5A is an exploded perspective view of a pressure sensor apparatus 18, and FIG. 5B is a diagram for description of a cover 320 and a shield member 350 of the pressure sensor apparatus 18. FIG. 5C is a plan view of the pressure sensor apparatus 18, FIG. 5D is a cross-sectional view along line E-E in FIG. 5C, and FIG. 5E is a cross-sectional view along line F-F in FIG. 5C.

The pressure sensor apparatus 18 is an apparatus capable of measuring absolute pressure in four spaces and is configured to include a substrate 300, screws 302a to 302f, sensors 310a to 310d, the cover 320, and the shield member 350. The substrate 300 is a member having an upside surface to which the sensors 310a to 310d are attached. For example, pattern wiring for applying power supply voltage to the sensors 310a to 310d, pattern wiring for transferring signals from the sensors 310a to 310d, and a ground pattern (not illustrated) are formed on the substrate 300.

The substrate 300 is provided with openings 301a to 301f corresponding to the respective screws 302a to 302f (described later). The screws 302a to 302f are members for fixing the substrate 300 to the cover 320.

<Sensor 310a>

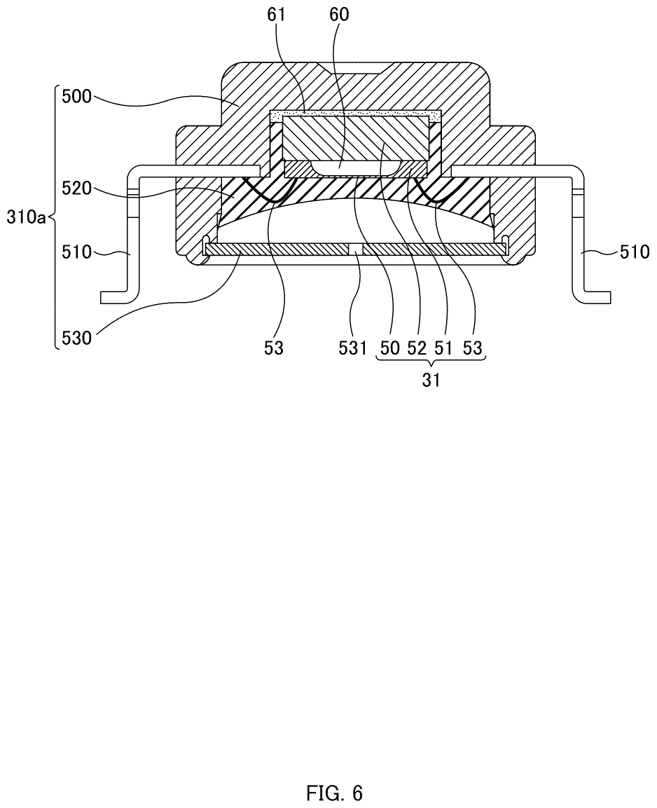

The sensor 310a measures the pressure (in this example, absolute pressure) of gas flowing in or out through an introduction pipe 321a (described later). FIG. 6 is a cross-sectional view along D-D line in FIG. 5A, and the sensor 310a is configured to include the measurement unit 31, a package 500, terminals 510, a protection member 520, and a cap 530. The measurement unit 31 included in the sensor 310a in FIG. 6 has the same configuration as illustrated in FIG. 2, for example. In FIG. 2, the measurement unit 31 is housed at a part recessed on the lower side in the package 30 so that the measurement unit 31 can measure the pressure of gas on the upper side of the measurement unit 31. In FIG. 6, the measurement unit 31 is housed at a part recessed on the upper side in the package 500 so that the measurement unit 31 can measure the pressure of gas on the lower side of the measurement unit 31.

The package 500 is a member made of, for example, resin and formed with the recessed part in which the measurement unit 31 is housed. The terminals 510 are metal members (so-called lead frames) similar to or the same as the terminals 32 in FIG. 2 and electrically couple the semiconductor chip 51 included in the measurement unit 31 to the substrate 300 together with the wires 53. The package 500 corresponds to a “housing part” in which the semiconductor chip 51 (that is, a semiconductor substrate) is housed.

The protection member 520 is a protection gel covering the measurement unit 31 and protecting the semiconductor chip 51 and the wires 53, of the measurement unit 31. The cap 530 is a member covering an opening on the lower side of the package 30 and made of, for example, resin.

An opening 531 for measuring pressure is provided substantially at the center of the cap 530. Accordingly, the sensor 310a in FIG. 6 can measure the pressure of gas from the lower side of the sensor 310a. The sensor 310a includes the cap 530 in this example, but is not limited thereto and may include no cap 530. In such a case as well, the sensor 310a can appropriately measure the pressure of gas.

The sensors 310b to 310d are devices configured to measure the absolute pressure of gas flowing in or out through respective introduction pipes 321b to 321d (described later). The sensors 310b to 310d have the same configuration as the sensor 310a, and thus detailed description thereof will be omitted.

### <Cover 320>

The cover 320 in FIG. 5A is attached to the upside surface of the substrate 300 from above to form housing spaces S10 to S13 (described later in detail) in which the respective sensors 310a to 310d are housed. As illustrated in FIGS. 5A and 5B, the cover 320 has a substantially rectangular parallelepiped shape and includes the introduction pipes 321a to 321d, screw holes 322a to 322f, a wall part 323, and partition parts 324a to 324c.

The introduction pipe 321a is a part formed with a hole 330a communicating with the housing space S10 (described later) and is provided at the side surface of the cover 320 on the front side. Similarly to the introduction pipe 321a, the introduction pipes 321b to 321d are parts formed with holes 330b to 330d communicating with the housing spaces S11 to S13 (described later), respectively, and are provided at the side surface of the cover 320 on the front side.

The screw holes 322a to 322f are holes corresponding to the respective openings 301a to 301f of the substrate 300 when the cover 320 is attached to the substrate 300, and the screws 302a to 302f are inserted into the respective screw holes.

The wall part 323 is a part surrounding a recessed part formed at the back surface of the cover 320, and a space surrounded by the wall part 323 is divided by the three partition parts 324a to 324c. As a result, the space surrounded by the wall part 323 is divided into four spaces by the three partition parts 324a to 324c.

In the present embodiment, the “housing space S10” is the rightmost space among the above-described four spaces and surrounded by the inside of the cover 320, a part 351a (described later) corresponding to an O ring, and the substrate 300. The “housing space S11” is the second rightmost space among the above-described four spaces and surrounded by the inside of the cover 320, a part 351b (described later) corresponding to an O ring, and the substrate 300.

The “housing space S12” is the third rightmost (that is, the second leftmost) space among the above-described four spaces and surrounded by the inside of the cover 320, a part 351c (described later) corresponding to an O ring, and the substrate 300. The “housing space S13” is the leftmost space among the above-described four spaces and surrounded by the inside of the cover 320, a part 351d (described later) corresponding to an O ring, and the substrate 300.

In this manner, in the present embodiment, the recessed part formed at the back surface of the cover 320 is divided by the three partition parts 324a to 324c, and accordingly, the four housing spaces S10 to S13 are formed.

<Shield member 350>

The shield member 350 is a member (seal) for sealing the housing spaces S10 to S13. As illustrated in FIG. 5B, the shield member 350 of the present embodiment is provided with the four parts 351a to 351d corresponding to O rings. The part 351a is a part for sealing the housing space S10, and the part 351b is a part for sealing the housing space S11. In addition, the part 351c is a part for sealing the housing space S12, and the part 351d is a part for sealing the housing space S13.

In the present embodiment, the four parts 351a to 351d have substantially square shapes in a plan view from above. The parts 351a and 351b share a side between the parts 351a and 351b, and accordingly include a part 352 common to both members. The parts 351b and 351c share a side between the parts 351b and 351c and accordingly include a part 353 common to both members, and the parts 351c and 351d share a side between the parts 351c and 351d and accordingly include a part 354 common to both members.

In the present embodiment, for example, the sensor 310a corresponds to a “first sensor”, and the sensor 310b corresponds to a “second sensor”. The housing space S10 corresponds to a “first housing space”, and the housing space S11 corresponds to a “second housing space”. The hole 330a corresponds to a “first hole”, and the hole 330b corresponds to a “second hole”. The part 351a of the shield member 350 for sealing the housing space S10 corresponds to a “first part”, and the part 351b of the shield member 350 for sealing the housing space S11 corresponds to a “second part”. The parts 351a and 351b include the common part 352.

### <Attachment of Cover 320 and Housing Space>

In the present embodiment, the cover 320 is attached to the substrate 300 in a state in which the shield member 350 is fitted to a groove (described later) at the back surface of the cover 320. Specifically, the screws 302a to 302f are inserted into the openings 301a to 301f and the screw holes 322a to 322f in a state in which the cover 320 is temporarily fixed to the substrate 300 by clicks of the cover 320.

The following description will be made on the part 352 of the shield member 350 with reference to FIG. 5D. A groove 360 to which the part 352 of the shield member 350 is fitted is formed at the partition part 324a of the cover 320 of the present embodiment. The part 352 of the shield member 350 eliminates the gap between the partition part 324a and the substrate 300 when the cover 320 is attached to the substrate 300 in a state in which the part 352 is fitted to the groove 360.

The above description is made on the gap between the partition part 324a and the substrate 300, and also applies to other places (for example, the gap between the partition part 324b and the substrate 300 and the gap between the partition part 324c and the substrate 300) where the groove 360 is formed and the shield member 350 is fitted. In addition, the groove 360 is formed at the wall part 323, and thus the shield member 350 eliminates the gap between the wall part 323 and the substrate 300. Accordingly, in the present embodiment, the housing spaces S10 to S13 are sealed when the holes 330a to 330d of the respective introduction pipes 321a to 321d are blocked.

As in FIG. 1A, tubes (not illustrated) are attached to the introduction pipes 321a to 321d of the cover 320 of the pressure sensor apparatus 18. In the present embodiment, the cover 320 directly contacts the substrate 300 but does not directly contact the sensors 310a to 310d. Thus, force is not directly applied to the sensors 310a to 310d through the cover 320, and accordingly, the pressure sensor apparatus 18 of the present embodiment can accurately measure absolute pressure in the housing spaces S10 to S13.

Although one shield member 350 is provided in the above description, for example, four O rings with which the four parts 351a to 351d are separated may be provided. However, a larger space in the right-left direction is needed in a case where four O rings are provided. In the present embodiment, since the shield member 350 includes the shared parts 352 to 354, space saving can be achieved even in a case where the four sensors 310a to 310d are disposed in the right-left direction.

In the pressure sensor apparatus 18, as illustrated in FIG. 5E, the sensor 310a is disposed such that the semiconductor chip 51 is not positioned on an extended line of a central axis A0 of the hole 330a (in this example, the central axis of an opening part of the introduction pipe 321a formed with the hole 330a). Accordingly, it is possible to reduce influence of dust or the like entering through the hole 330a on the semiconductor chip 51. Moreover, with such disposition, for example, the sensor 310a can stably operate without the cap 530 of the sensor 310a, which leads to cost reduction.

In the present embodiment, for example, as illustrated in FIG. 6, the semiconductor chip 51 of the sensor 310a is positioned between the package 500 and the substrate 300 when housed in the package 500. Even when dust or the like enters inside the housing space S10, the dust is unlikely to move upward from the substrate 300 side (lower side) and affect the semiconductor chip 51. Thus, the pressure sensor apparatus 18 can measure absolute pressure in the housing space S10 without influence of dust or the like.

### <<Pressure Sensor Apparatus 19>>

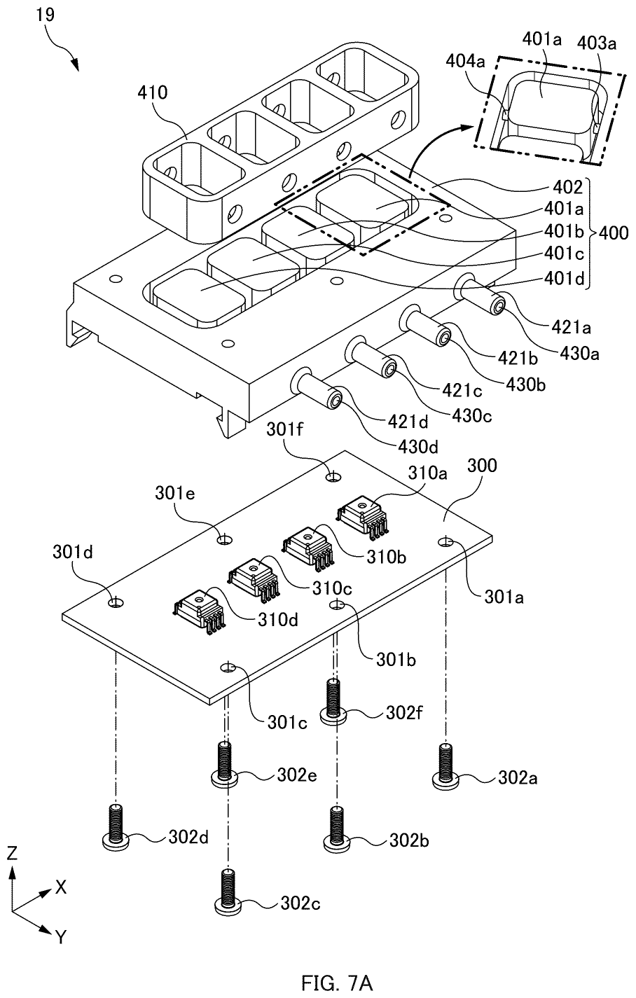

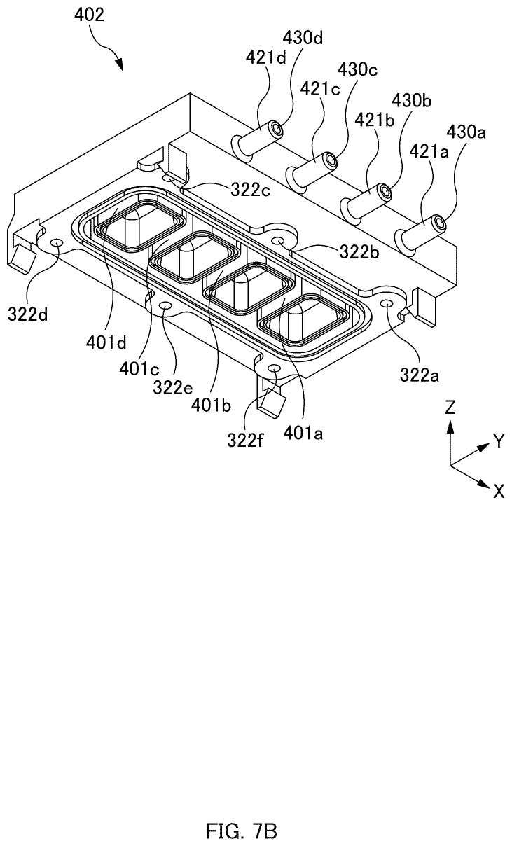

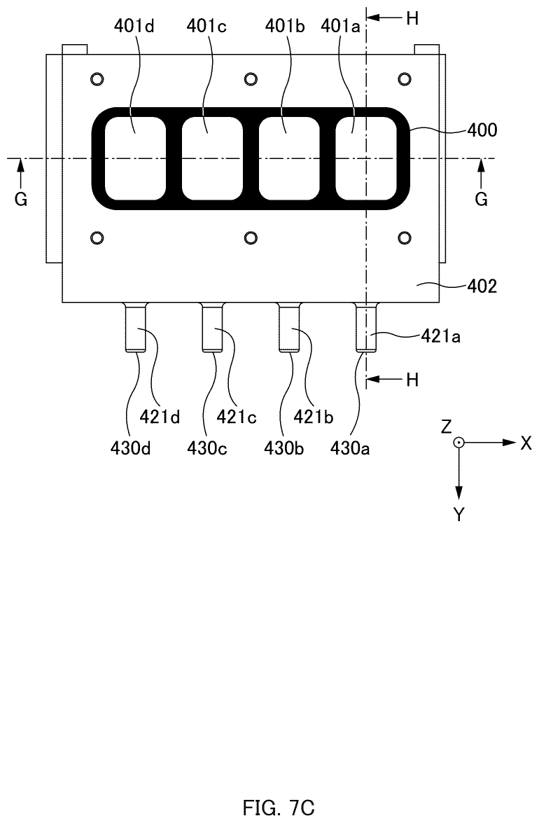

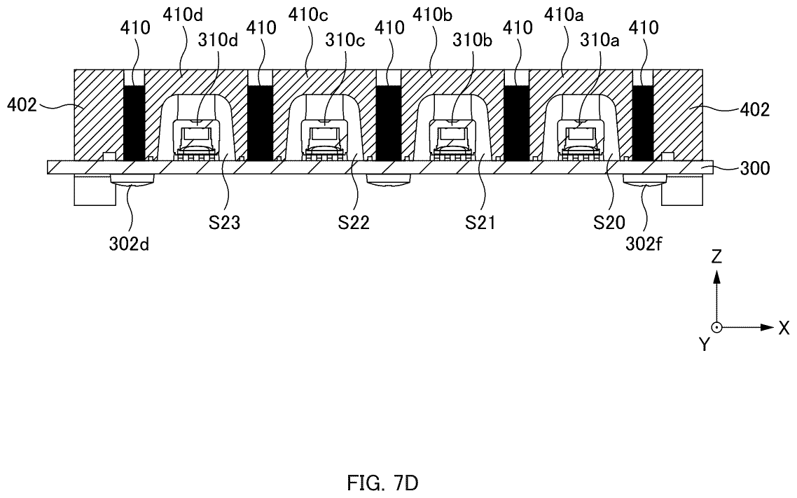

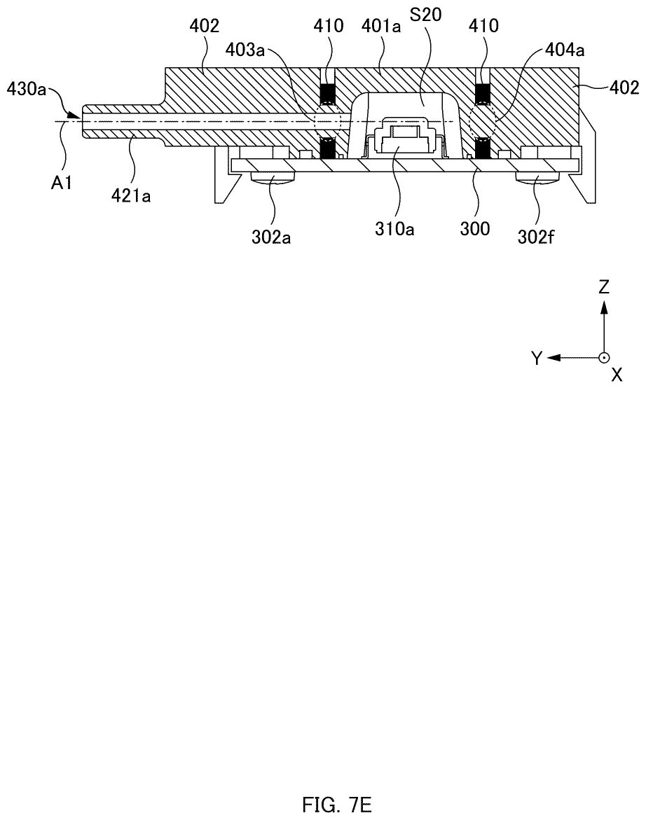

FIG. 7A is an exploded perspective view of a pressure sensor apparatus 19, FIG. 7B is a diagram for description of a first member 401 and a second member 402, and FIG. 7C is a plan view of the pressure sensor apparatus 19. FIG. 7D is a partial cross-sectional view along line G-G in FIG. 7C, and FIG. 7E is a partial cross-sectional view along line H-H in FIG. 7C.

The pressure sensor apparatus 19 is an apparatus capable of measuring absolute pressure in four spaces and includes the substrate 300, the screws 302a to 302f, the sensors 310a to 310d, a cover 400, and a bonding agent 410. The substrate 300, the screws 302a to 302f, and the sensors 310a to 310d are the same as in the pressure sensor apparatus 18, and thus the following description will be mainly made on the cover 400 and the bonding agent 410. Although described later in detail, the bonding agent 410 has a predetermined shape in FIG. 7A, for example, which illustrates a solid state of the bonding agent 410 that is liquid.

### <Cover 400>

The cover 400 is attached to the upside surface of the substrate 300 from above to form housing spaces S20 to S23 (described later in detail) in which the respective sensors 310a to 310d are housed. The cover 400 is configured to include first members 401a to 401d having hollow spaces, the second member 402, coupling parts 403a to 403d and 404a to 404d, and introduction pipes 421a to 421d.

The “housing space S20” is a space surrounded by the inside of the first member 401a, the bonding agent 410 (described later), and the substrate 300, and the “housing space S21” is a space surrounded by the inside of the first member 401b, the bonding agent 410, and the substrate 300. The “housing space S22” is a space surrounded by the inside of the first member 401c, the bonding agent 410, and the substrate 300, and the “housing space S23” is a space surrounded by the inside of the first member 401d, the bonding agent 410, and the substrate 300.

The first member 401a is a member covering the sensor 310a disposed on the substrate 300 and providing the housing space S20 in which the sensor 310a is housed (that is, a member having a hollow space inside) (refer to FIG. 7B, for example). Similarly to the first member 401a, the first members 401b to 401d are members providing the housing spaces S21 to S23 in which the sensors 310b to 310d are housed, respectively.

The second member 402 is a member having a substantially rectangular parallelepiped shape and formed with an opening surrounding the first members 401a to 401d at a central part in a plan view. The introduction pipes 421a to 421d are provided at the side surface of the second member 402 on the front side so that the housing spaces S20 to S23 communicate with the outside.

The introduction pipe 421a is formed with a hole 430a communicating with the housing space S20. Similarly to the introduction pipe 421a, the introduction pipes 421b to 421d are formed with holes 430b to 430d communicating with the housing spaces S21 to S23, respectively. The screw holes 322a to 322f corresponding to the respective screws 302a to 302f are provided at the back surface of the second member 402.

The coupling part 403a is a member coupling the first member 401a and the second member 402 at the surface of the first member 401a on the front side. The coupling part 404a is a member coupling the first member 401a and the second member 402 at the surface of the first member 401a on the back side. The coupling part 403a has a tubular shape communicating with the hole 430a of the introduction pipe 421a. Accordingly, the coupling part 403a corresponds to the introduction pipe 421a substantially.

Although not illustrated for convenience, the coupling parts 403b to 403d are the same as the coupling part 403a, and the coupling parts 404b to 404d are the same as the coupling part 404a. Specifically, the coupling parts 403b and 404b couple the first member 401b and the second member 402, the coupling parts 403c and 404c couple the first member 401c and the second member 402, and the coupling parts 403d and 404d couple the first member 401d and the second member 402. Hereinafter, the four coupling parts 403a to 403d are also collectively referred to as a coupling part 403, and the four coupling parts 404a to 404d are also collectively referred to as a coupling part 404. The coupling part 403 of the present embodiment corresponds to a “pipe”.

Similarly to the above-described pressure sensor apparatus 17 in FIGS. 4A to 4C, the pressure sensor apparatus 19 has a gap between the first members 401a to 401d and the second member 402. In the present embodiment, the bonding agent 410 filling (gap) between each of the first members 401a to 401d and the second member 402 can eliminate the gap between each of the first members 401a to 401d and the second member 402. Similarly to the above-described bonding agent 205, the bonding agent 410 of the present embodiment is, for example, a potting material of silicon resin.

In the present embodiment, the coupling parts 403 and 404 are provided at positions separated from the substrate 300 when the cover 400 is attached to the substrate 300. Accordingly, the bonding agent 410 can reliably eliminate the gap between each of the four first members 401a to 401d and the second member 402. In this manner, the bonding agent 410 of the present embodiment shields the inside of the housing spaces S20 to S23 from the outside so that the housing spaces S20 to S23 are sealed when the holes 430a to 430d are blocked.

As in FIG. 1A, a tube (not illustrated) is attached to each of the introduction pipes 421a to 421d of the cover 400 of the pressure sensor apparatus 19. In the present embodiment, the cover 400 directly contacts the substrate 300 but does not directly contact the sensors 310a to 310d. Thus, force is not directly applied to the sensors 310a to 310d through the cover 400, and accordingly, the pressure sensor apparatus 19 of the present embodiment can accurately measure absolute pressure in the housing spaces S20 to 23.

In the pressure sensor apparatus 19, as illustrated in FIG. 7E, the sensor 310a is disposed such that the semiconductor chip 51 is not positioned on an extended line of a central axis A1 of the hole 430a (in this example, the central axis of an opening part of the introduction pipe 421a formed with the hole 430a). Accordingly, it is possible to reduce influence of dust or the like entering through the hole 430a on the semiconductor chip 51. Moreover, with such disposition, for example, the sensor 310a can stably operate without the cap 530 of the sensor 310a, which leads to cost reduction.

### <<Another Embodiment of Pressure Sensor Apparatus 15>>

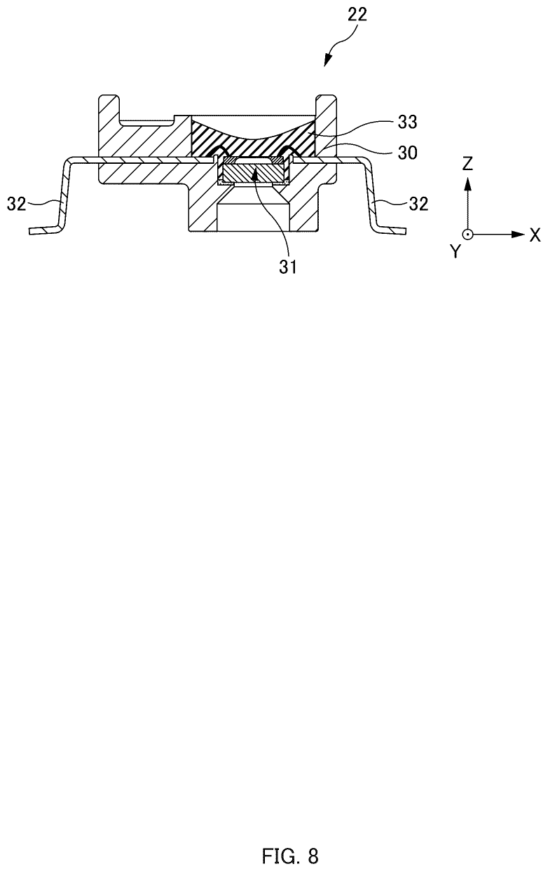

Although the cap 34 is provided in the sensor 21 illustrated in FIG. 2, a tube is attached to an introduction pipe of a cover in a case where the sensor 21 is applied to the pressure sensor apparatuses 15 to 17, and thus the cap 34 does not necessarily need to be provided. For example, a sensor 22 without the cap 34 may be employed as illustrated in FIG. 8.

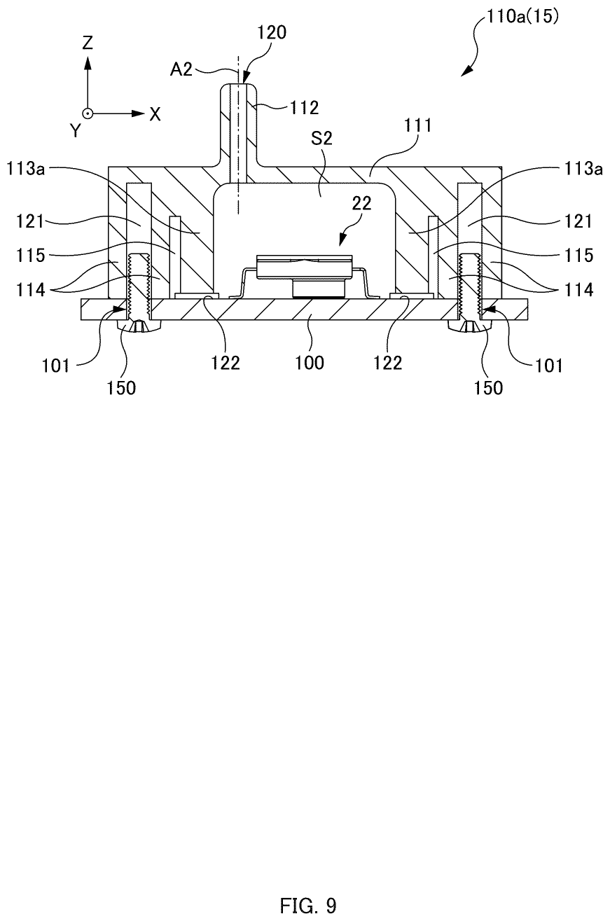

FIG. 9 is an example of a partial cross-sectional view of the pressure sensor apparatus 15 including the sensor 22 without the cap 34. In FIG. 9, the position of the introduction pipe 112 is changed to an end part (for example, an end part on the left side) of the ceiling part 111 such that the semiconductor chip 51 is not positioned on an extended line of a central axis A2 of the hole 120 (central axis of an opening part of the introduction pipe 112 formed with the hole 120). Thus, even when dust or the like enters the housing space S2 through the hole 120 of the pressure sensor apparatus 15 illustrated in FIG. 9, the dust is unlikely to directly contact the measurement unit 31 (the semiconductor chip 51, in particular).

In this manner, degradation of the measurement accuracy can be prevented since the position of the introduction pipe 112 is changed to an end part (for example, the end part on the left side) of the ceiling part 111 such that the semiconductor chip 51 is not positioned on the extended line of the central axis A2 of the hole 120.

The above description is made on an example of the sensor 22 without the cap 34 for convenience but is also applicable to the sensor 21 in FIG. 3B. With omission of the cap 34, cost reduction can be achieved for the sensor 22 as compared to the sensor 21.

### Summary

The pressure sensor apparatuses 15 to 19 of the present embodiment are described above. For example, in the pressure sensor apparatus 15 illustrated in FIG. 3B, a tube is attached to the introduction pipe 112 of the cover 110a. In such an embodiment, when the tube is attached to the cover 110a, force is not directly applied to the sensor 21 in the housing space S2 from the cover 110a. Thus, the pressure sensor apparatus 15 can prevent degradation of the measurement accuracy of the sensor 21.

As described for the pressure sensor apparatuses 15 and 16, for example, the bonding agent 122 and the O ring 126 can be provided as a “seal”. With such a seal, the housing spaces S2 and S3 can be sealed.

For example, in the cover 110a of the pressure sensor apparatus 15, the attachment parts 114 are provided outside the wall part 113a. With such attachment parts 114, the cover 110a can be easily attached to the substrate 100.

As illustrated in FIG. 3B, the openings 101 are formed on the substrate 100, and the screw holes 121 are formed in the attachment parts 114. The cover 110a and the substrate 100 are fixed by using the screws 150 corresponding to the openings 101 and the screw holes 121.

In the pressure sensor apparatus 15, each slit 115 is formed between the wall part 113a and the corresponding attachment part 114. Accordingly, force can be prevented from being conveyed to the sensor 21 side when the cover 110a is attached to the substrate 100 by the screws 150, and thus degradation of the measurement accuracy of the sensor 21 can be prevented.

The pressure sensor apparatus 17 includes the first member 200, the second member 201 surrounding the first member, and the coupling parts 202a to 202d coupling the first member 200 and the second member 201. With such a configuration, the housing space S4 in which the sensor 21 is housed can be formed by filling the gap between the first member 200 and the second member 201 with the bonding agent 205 (in this example, a potting material). In such a pressure sensor apparatus 17, as well, force is not directly applied to the sensor 21 in the housing space S4 from the cover 140 when a tube is attached to the cover 140. Thus, the pressure sensor apparatus 17 can prevent degradation of the measurement accuracy of the sensor 21.

In the pressure sensor apparatus 17, the attachment parts 203 are provided outside the second member 201. With such attachment parts 203, the cover 140 can be easily attached to the substrate 100.

The cover 140 is attached to the substrate 100 by using the screws 150 corresponding to the screw holes 231 of the attachment parts 203.

In the pressure sensor apparatus 17, each slit 204 is formed between the second member 201 and the corresponding attachment part 203. Accordingly, force can be prevented from being conveyed to the sensor 21 side when the cover 140 is attached to the substrate 100 by the screws 150, and thus degradation of the measurement accuracy of the sensor 21 can be prevented.

For example, in the pressure sensor apparatus 19 illustrated in FIG. 7D, the coupling part 403a is part of the introduction pipe 421a. With such a coupling part 403a, the first member 401a and the second member 402 can be reliably coupled to each other and the housing space S20 can communicate with the outside.

For example, as illustrated in FIGS. 5E, 7E, and 9, the semiconductor chip 51 is not positioned on the extended lines of the axes A0 to A2 in the present embodiment. With this configuration, it is possible to reduce influence of dust or the like on the semiconductor chip 51.

In the sensor 310a illustrated in FIG. 6, for example, the package 500 in which the semiconductor chip 51 is housed is positioned on the upper side of the semiconductor chip 51, and the substrate 300 to which the sensor 310a is attached is positioned on the lower side of the semiconductor chip 51. In other words, the semiconductor chip 51 is positioned between the package 500 and the substrate 300 in the present embodiment. With this configuration, it is possible to lower the probability of influence of dust or the like on the semiconductor chip 51 even in a case where no cap is provided.

In the pressure sensor apparatus 18, the shield member 350 includes the part 352 common to the parts 351a and 351b. Thus, space saving is possible even in a case where a plurality of sensors 310 are disposed on the substrate 300.

The present disclosure is made in view of the conventional problem as described above and intended to provide a pressure sensor apparatus capable of reducing degradation of the accuracy of pressure measurement.

According to the present disclosure, it is possible to provide a pressure sensor apparatus capable of reducing degradation of the accuracy of pressure measurement.

Embodiments of the present disclosure described above are simply to facilitate understanding of the present disclosure and are not in any way to be construed as limiting the present disclosure. The present disclosure may variously be changed or altered without departing from its essential features and encompass equivalents thereof.

What is claimed is:

1. A pressure sensor apparatus comprising:
a substrate;
a sensor provided on the substrate and configured to measure absolute pressure;
a cover attached to the substrate to form a housing space, in which the sensor is housed, with the substrate; and
a shield member, wherein
the cover is attached to the substrate with the shield member disposed therebetween and fully blocking passage of air therebetween, and
the cover has a hole through which the housing space communicates with an outside of the housing space.

2. The pressure sensor apparatus according to claim 1, wherein
the cover includes a ceiling part and a wall part, the wall part being positioned between the ceiling part and the substrate, and surrounding the housing space in a plan view of the pressure sensor apparatus, and
the shield member is a seal positioned between the wall part and the substrate.

3. The pressure sensor apparatus according to claim 2, wherein
the cover further includes an attachment part, which is attached to the substrate and is provided further outside than the wall part with respect to the housing space.

4. The pressure sensor apparatus according to claim 3, further comprising:
a screw for fixing the cover to the substrate, wherein
the substrate has an opening formed therein corresponding to the screw, and
the attachment part has a screw hole formed therein corresponding to the screw.

5. The pressure sensor apparatus according to claim 4, wherein
the cover further has a slit between the wall part and the attachment part.

6. The pressure sensor apparatus according to claim 1, wherein:
the cover further includes:
a first member attached to the substrate to form the housing space with the substrate,
a second member surrounding the first member, and
a coupling part coupling the first member and the second member, the coupling part is provided at a position separated from the substrate, and
the shield member is filled between the first member and the second member.

7. The pressure sensor apparatus according to claim 6, wherein
the cover further includes an attachment part, which is attached to the substrate and is provided further outside than the second member with respect to the housing space.

8. The pressure sensor apparatus according to claim 7, further comprising:
a screw fixing the cover to the substrate, wherein
the substrate has an opening formed therein corresponding to the screw, and
the attachment part has a screw hole formed therein corresponding to the screw.

9. The pressure sensor apparatus according to claim 8, wherein
the cover further has a slit between the second member and the attachment part.

10. The pressure sensor apparatus according to claim 6, wherein
the coupling part is formed by a pipe with the hole passing therethrough.

11. The pressure sensor apparatus according to claim 1, wherein
the sensor includes a semiconductor substrate, and
the semiconductor substrate is not aligned with a central axis of the hole.

12. The pressure sensor apparatus according to claim 1, wherein
the sensor includes a semiconductor substrate and a housing part in which the semiconductor substrate is housed, and
the semiconductor substrate is positioned between the housing part and the substrate.

13. A pressure sensor apparatus comprising:
a substrate;
a first sensor provided on the substrate and configured to measure absolute pressure;
a second sensor provided on the substrate and configured to measure the absolute pressure;
a cover attached to the substrate to form a first housing space, in which the first sensor is housed, and a second housing space, in which the second sensor is housed, with the substrate; and
a shield member, wherein
the cover has
a first hole through which the first housing space communicates with an outside of the first housing space, and
a second hole through which the second housing space communicates with an outside of the second housing space,
the shield member is positioned between the cover and the substrate, and is configured to fully block passage of air therebetween, and
the shield member includes
a first part and a second part that enclose the first housing space and the second housing space respectively in a plan view of the pressure sensor apparatus, and
the first part and the second part share a common part.
